(19) United States
(12) Patent Application Publication
(10) Pub. No.: US 2025/0028995 A1
(43) Pub. Date: Jan. 23, 2025

(54) TRAINING AND APPLICATION OF BOTTLENECK MODELS AND EMBEDDINGS

(71) Applicant: X Development LLC, Mountain View, CA (US)

(72) Inventors: Rishabh Singh, San Jose, CA (US); David Andre, San Francisco, CA (US); Garrett Raymond Honke, Mountain View, CA (US); Falak Shah, Ahmedabad (IN); Nisarg Vyas, Ahmedabad (IN); Jayendra Parmar, Mahesana (IN); Brian M. Rosen, San Francisco, CA (US); Shaili Trivedi, Ahmedabad (IN)

(21) Appl. No.: 18/224,889

(22) Filed: Jul. 21, 2023

(51) Int. Cl. G06N 20/00

(52) U.S. Cl. CPC G06N 20/00

(57) ABSTRACT

Disclosed implementations relate to adding “bottleneck” models to machine learning pipelines that already apply domain models to translate and/or transfer representations of high-level semantic concepts between domains. In various implementations, an initial representation in a first domain of a transition from an initial state of an environment to a goal state of the environment may be processed based on a pre-trained first domain encoder to generate a first embedding that semantically represents the transition. The first embedding may be processed based on one or more bottleneck models to generate a second embedding with fewer dimensions than the first embedding. In various implementations, the second embedding may be processed in various ways to train one or more of the bottleneck model(s) based on various different auxiliary loss functions.

### BACKGROUND

Machine learning models may be used to process a representation of a semantic concept, such as a transition of an environment from an initial state to a goal state, in one domain or modality and generate corresponding representations (e.g., “inferences,” “translations”) in other domains or modalities. As one example, the following natural language may be used to describe a task of purchasing an airline ticket: “Go to xyztravel's website and purchase a plane ticket from Louisville to Detroit on September 6.” A machine learning model such as a large language model (LLM) may be applied to this natural language to generate computer code in a particular programming language that, when executed, automatically carries out the task described in the natural language. In other words, the natural language and the generated computing code are representations of the same semantic concept in different domains.

### SUMMARY

The same semantic concept can be described or expressed within a single domain in many different ways. For instance, the above-described task can be articulated using alternative natural language in far greater detail, such as “navigate browser to xyztravel.com/purchase/, find ‘origin’ field, populate ‘origin’ field with ‘Louisville’, find ‘destination’ field, populate ‘destination’ field with ‘Detroit’, find ‘date’ field, populate ‘date’ field with ‘Sep. 6, 2023’, find ‘submit’ button, actuate ‘submit’ button.” While both natural language examples represent the same semantic concept, the latter is expressed with far more granularity than would be necessary for human understanding.

When translating representations of semantic concepts between domains, various intermediate representations (also referred to as “transferrable representations”) may be generated (e.g., “encoded”), often with fewer dimensions than the original representations. These intermediate representations can take various forms, such as continuous vector embeddings, natural language descriptions, etc. It may be the case that two intermediate representations that ostensibly represent the same semantic concept are relatively dissimilar to each other, e.g., in embedding space. For instance, the two different natural language examples described previously, if processed using machine learning/natural language processing, may yield embeddings that are relatively distant from each other in embedding space, in spite of their representing the same high-level semantic concept. Likewise, intermediate representations encoded from of two representations of a semantic concept in different domains also might be relatively distant from each other in embedding space. As a consequence, interpreting intermediate embeddings can be challenging.

Implementations described herein relate to adding “bottleneck” models to machine learning pipelines that already apply domain models to translate and/or transfer representations of high-level semantic concepts between domains. These added bottleneck models are designed and/or trained to generate intermediate representations that are more semantically succinct, consistent, and coherent than those generated using the domain models, e.g., by reducing their dimensionality. These bottleneck intermediate representations may be more interpretable than the uncondensed (or “unabridged”) intermediate representations generated based on the domain models, e.g., because the bottleneck intermediate representations may be grounded to natural language or to another interpretable form.

In some implementations, a method may be implemented using one or more processors and may include: providing an initial representation in a first domain of a transition from an initial state of an environment to a goal state of the environment; processing the initial representation in the first domain based on a pre-trained first domain encoder to generate a first embedding that semantically represents the transition; processing the first embedding based on one or more bottleneck models to generate a second embedding with fewer dimensions than the first embedding, wherein the second embedding also semantically represents the transition; processing the second embedding using a pre-trained second domain decoder to generate a first predicted representation of the transition from the initial state of the environment to the goal state of the environment, wherein the first predicted representation is in the second domain; processing the first predicted representation using a pre-trained second domain encoder to generate a third embedding that semantically represents the transition; based on the third embedding, generating a second predicted representation of the transition from the initial state of the environment to the goal state, wherein the second predicted representation is in the first domain; comparing one or more features of the second predicted representation of the transition to one or more features of the initial representation of the transition; and training one or more of the bottleneck models based on the comparing.

In various implementations, the initial representation may include an original natural language snippet describing, in a first language, the transition from the initial state of the environment to the goal state of the environment. In various implementations, the method may further include: processing the second embedding using a translation decoder to generate a predicted translation of the natural language snippet in a second language that is different from the first language; translating the predicted translation of the natural language snippet into a second predicted natural language snippet in the first language; and based on a comparison of the original natural language snippet to the second predicted natural language snippet in the first language, training one or more of the bottleneck models.

In various implementations, the generating may include processing the third embedding using a first domain decoder to generate the second predicted representation of the transition from the initial state of the environment to the goal state. In various implementations, the one or more bottleneck models may include a first bottleneck model, and the generating may include: processing the third embedding using the first bottleneck model or a second bottleneck model to generate a fourth embedding with fewer dimensions than the third embedding; and based on the fourth embedding, generating the second predicted representation of the transition from the initial state of the environment to the goal state. In various implementations, generating the second predicted representation based on the fourth embedding may include decoding the fourth embedding using a first domain decoder. In various implementations, generating the second predicted representation based on the fourth embedding may include decoding the fourth embedding using the first bottleneck model.

In various implementations, the comparing may include comparing the goal state of the initial representation with a predicted goal state of the second predicted representation of the transition. In various implementations, the environment may take the form of a computer application executing on a computing device. In various implementations, the environment may be a real or simulated space, the initial state may be an initial arrangement of one or more real or simulated objects in the space, and the goal state may be a goal arrangement of the one or more real or simulated objects in the space.

In various implementations, the first domain may be a computer programming language domain and the second domain comprises demonstration input/output pairs. In various implementations, one or more of the bottleneck models may take the form of a transformer model.

In another aspect, a method may be implemented using one or more processors and may include: providing an initial representation in a first domain of a transition from an initial state of an environment to a goal state of the environment; processing the initial representation in the first domain based on a pre-trained first domain encoder to generate a first embedding that semantically represents the transition; processing the first embedding based on one or more bottleneck models to generate a second embedding with fewer dimensions than the first embedding; processing the second embedding using a pre-trained decoder for a second domain to generate a first predicted representation of the transition from the initial state of the environment to the goal state of the environment, wherein the first predicted representation is in the second domain; processing the first predicted representation using a pre-trained second domain encoder to generate a third embedding that semantically represents the transition; processing the third embedding based on one or more of the bottleneck models to generate a fourth embedding with fewer dimensions than the third embedding; translating the second and fourth embeddings into a third domain that is different from the first and second domains to generate, respectively, first and second representations in the third domain of the transition from the initial state of the environment to the goal state of the environment; and based on a comparison of the first and second representations in the third domain, training one or more of the bottleneck models.

In addition, some implementations include one or more processors of one or more computing devices, where the one or more processors are operable to execute instructions stored in associated memory, and where the instructions are configured to cause performance of any of the aforementioned methods. Some implementations include at least one non-transitory computer readable storage medium storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 is a schematic diagram of an example environment in which implementations disclosed herein may be implemented.

FIG. 2 schematically illustrates an example of how data may be exchanged and/or processed across domains, in accordance with various implementations.

FIG. 3 schematically illustrates another example of how data may be exchanged and/or processed across domains using bottleneck models configured with selected aspects of the present disclosure, in accordance with various implementations.

FIG. 4 schematically illustrates another example of how data may be exchanged and/or processed across domains using a bottleneck model configured with selected aspects of the present disclosure, in accordance with various implementations.

FIG. 5 depicts an example method for practicing selected aspects of the present disclosure, in accordance with various implementations.

FIG. 6 depicts another example method for practicing selected aspects of the present disclosure, in accordance with various implementations.

FIG. 7 depicts another example method for practicing selected aspects of the present disclosure, in accordance with various implementations.

FIG. 8 illustrates an example architecture of a computing device.

### DETAILED DESCRIPTION

Implementations are described herein for adding “bottleneck” models to machine learning pipelines that already apply domain models to translate and/or transfer representations of high-level semantic concepts between domains. These added bottleneck models may be designed and/or trained to generate intermediate representations-including “bottleneck intermediate representations”, “bottleneck transferable representations,” and/or “bottleneck embeddings”—that are semantically more succinct, consistent, and/or coherent than those generated using the domain models, e.g., by reducing their dimensionality. These bottleneck intermediate representations may be more interpretable than the uncondensed (or “unabridged”) intermediate representations generated based on the domain models, e.g., because the bottleneck intermediate representations may be grounded to natural language or to another interpretable form.

Semantic concepts as described herein may include, among other things, transitions of various types of environments from initial states to goal states. These environments may include, for instance, robot and/or robot planners, real or simulated spaces (e.g., in which real/simulated robots may operate), computer applications, self-driving vehicles, and so forth. Initial and goal states may take various forms depending on the type of environment. In a real or simulated two-dimensional (2D) or three-dimensional (3D) space, for instance, an initial state may include an arrangement and/or pose(s) of one or more objects or items, and a goal state may include a target arrangement and/or pose(s) of the one or more objects or items. In some cases, semantic concepts may be represented as sequences of actions that affect a transition of an environment from an initial state to a goal state. Additionally or alternatively, in some cases, semantic concepts may be represented as pairs of examples that represent initial and goal states, e.g., before and after images, before and after states of documents or applications, input/output pairs, etc.

In a computer application, an initial state may be, for instance, a blank document or a document with content (e.g., a generic letter template), and a goal state may be, for instance, the same document with content added and/or altered (e.g., the letter template filled out with real data). This transition may be expressed in one domain specific language (DSL) as the initial document and the final document, and in another DSL as a sequence of computing interactions (e.g., keystrokes, mouse movements, graphical element operations, etc.) that affect the transition. As another similar example, with a web browser, an initial state may be no webpage yet loaded, an initial webpage, an initial page with form fields not yet populated, etc. A goal state of the web browser may be, e.g., a target webpage, the same webpage with the form fields populated with data, etc. The transition between these states may be expressed directed (e.g., before and after) or as a sequence of actions that affect the transition.

In the self-driving domain, an initial state may be a first location and a goal state may be a second location. This transition can be expressed in one DSL as a pair of locations. In another DSL, the transition can be expressed as a sequence of directions forming a path between the first and second locations. In yet another DSL, the transition can be expressed as a sequence of actions performed by the self-driving vehicle, such as accelerate for a particular distance, slow to a stop, turn the wheel 85 degrees to the right, accelerate once again, maintain velocity for x distance, etc.

Machine learning models described herein can take various architectural forms. Domain models and/or bottleneck models, for example, can be different types of sequence-to-sequence models, such as transformer networks with self-attention mechanisms, autoregressive models, and other types of models that are often trained as LLMs. Machine learning models described herein may take other forms as well, such a feed forward neural networks, convolutional neural networks (CNNs), various types of recurrent neural networks (RNNs) such as long short-term memory (LSTM) networks or gated recurrent unit (GRU) networks, support vector machines, random forests, etc.

In some implementations, domain models may be trained initially to translate between domains. For example, a representation or expression of a semantic concept in the DSL of one domain (e.g., natural language) can be encoded using a first domain model into an intermediate representation such as a semantically rich embedding. That semantically rich embedding may then be decoded by a second domain model to generate a representation or expression of the same semantic concept in the second domain's DSL.

Intermediate representations may represent, in the abstract, a “semantic concept” or “semantic task” that can be translated into action spaces of any number of domains using respective domain models. Put another way, a “semantic task” or “semantic concept” is a domain-agnostic, higher order task which finds expression within a particular domain in that domain's DSL and/or as a sequence/plurality of domain-specific actions.

As noted previously, intermediate representations of the same semantic concept may differ from each other depending on which domain model was used to generate them. That makes interpreting these intermediate representations difficult. Moreover, the intermediate representations generated by domain models may be burdened with suboptimal and/or extraneous information (e.g., noise) contained in the original domain representation. A snippet of source code may include lines of code that implement the bubble sort algorithm, which is far less efficient than the quicksort sorting algorithm. A natural language description of a transition of an environment may be far more detailed and/or granular than is necessary for human understanding. A sequence of robot commands may be more granular than necessary to cause a semi-autonomous robot to perform a high-level task. And so on.

Accordingly, bottleneck models may be trained, e.g., separately from domain models (e.g., the domain models may be held constant while training the bottleneck models), to condense intermediate representations generated by the domain models into more succinct and/or uniform/normalized bottleneck intermediate representations of the underlying semantic concepts. For example, when generating a bottleneck embedding based on the intermediate representation of the source code snippet containing the inefficient bubble sort algorithm, the bottleneck transformer may remove (or abstract away) any features of the intermediate representation that correspond specifically to bubble sorting, leaving only feature(s) that represent sorting in general. As a consequence, source code generated by another domain model based on the condensed embedding may include a more efficient sorting algorithm than bubble sort.

In some implementations, a separate bottleneck model may be trained for each domain model. In other implementations, the same bottleneck model may be trained to process multiple different domains/modalities of data. Bottleneck models may include encoder portions and/or decoder portions. In some implementations, bottleneck embeddings may be decoded first by a bottleneck decoder and then decoded further using a target domain model. In other implementations, the bottleneck embedding may be decoded directly based on the domain model (in which case the bottleneck model may or may not have a decoder portion).

Bottleneck models may be trained based on a variety of different auxiliary loss functions. Minimizing some loss auxiliary functions may ensure that bottleneck embeddings represent semantic concepts accurately. This may in turn ensure that bottleneck embeddings can be used to accurately translate the same semantic concept across different domains. Minimizing other auxiliary loss functions (e.g., contrastive learning) may ensure that bottleneck embeddings representing the same semantic concept are consistent no matter which domain from which they originated. This may allow for simpler communication and translation across domains.

Minimizing yet other auxiliary loss functions may ensure that bottleneck embeddings remain interpretable. For example, bottleneck embeddings may be grounded to natural language in a first language by generating a natural language snippet in a second language based on the bottleneck embedding, translating the natural language snippet in the second language to the first language (e.g., using a neural translator, heuristics, etc.), and then comparing the first language translation to a ground truth natural language snippet that, for instance, was used to generate the bottleneck embedding in the first place. Based on the comparing, the bottleneck model may be trained.

Minimizing some auxiliary loss functions may ensure that bottleneck embeddings represent semantic concepts as succinctly as possible, e.g., with little or no extraneous information or noise. Suppose an environment takes the form of a 2D grid of cells, with each cell being capable of rendering various colors. Suppose further that in an initial state of the environment, a pattern drawn using the cells has a first orientation, and that in a goal state of the environment, the same pattern is rotated ninety degrees clockwise. A sampled source code snippet designed to affect this transition may include verbose instructions to manually (and inefficiently) recolor every single cell in the 2D grid, regardless of whether each cell is actually changed between the initial and goal states. Assume the sampled source code snippet is translated from a first domain associated with the programming language in which the source code was written to a second domain in which the DSL includes pairs of demonstration input/output images depicting the 2D grid in initial and goal states.

If the pair of demonstration input/output images (with the goal state image depicting the pattern rotated) are then translated from the second domain back into the first domain, the resulting predicted source code snippet may carry out the high-level concept (rotate the pattern) with far fewer instructions than the original source code snippet. The resulting predicted source code can therefore be used as training data to train a bottleneck model to generate a bottleneck embedding (e.g., based on the intermediate representation generated using the first domain model) that more succinctly represents the essential part(s) (rotated pattern) of the semantic concept, without extraneous information (e.g., instructions to recolor pixels that did not need to be recolored).

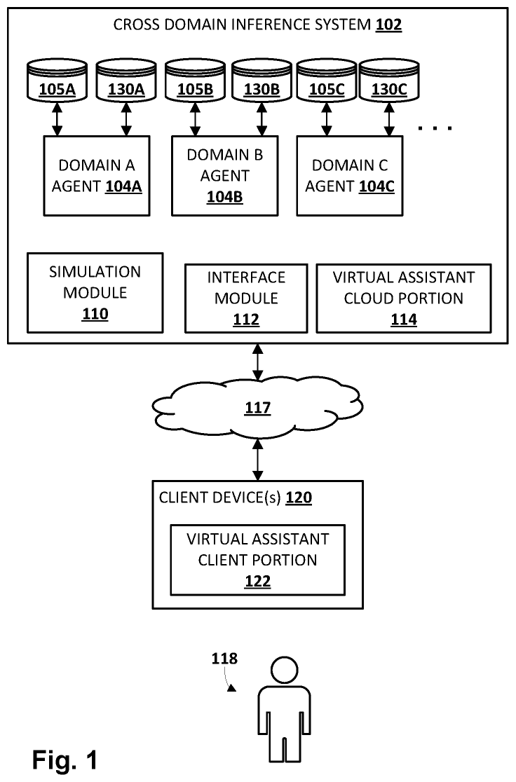

FIG. 1 schematically depicts an example environment in which selected aspects of the present disclosure may be implemented, in accordance with various implementations. Any computing devices depicted in FIG. 1 or elsewhere in the figures may include logic such as one or more microprocessors (e.g., central processing units or “CPUs”, graphical processing units or “GPUs”, tensor processing units or (“TPUs”)) that execute computer-readable instructions stored in memory, or other types of logic such as application-specific integrated circuits (“ASIC”), field-programmable gate arrays (“FPGA”), and so forth. Some of the systems depicted in FIG. 1, such as a cross domain inference system 102, may be implemented using one or more server computing devices that form what is sometimes referred to as a “cloud infrastructure,” although this is not required. In other implementations, aspects of cross domain inference system 102 may be implemented on client devices 120, e.g., for purposes of preserving privacy, reducing latency, etc.

Cross domain inference system 102 may include any number of different components configured with selected aspects of the present disclosure. These may include any number of modules that implement machine-learning based processes (sometimes referred to as stochastic processes), including a number of domain agents 104A, 104B, 104C, . . . . Domain agents 104A, 104B, 104C, . . . may be implemented using any combination of hardware and software and may be configured to translate representations of semantic concepts, such as transitions of environments from initial states to goal states, between respective domains they serve.

Each domain agent 104 may include and/or have access to one or more domain models 105 and some number of bottleneck models 130. For example, in FIG. 1, first domain agent 104A includes first domain model(s) 105A and a first bottleneck model 130A. Second domain agent 104B includes second domain model(s) 105B and a second bottleneck model 130B. And so on. In other implementations, rather than each domain agent 104 having its own bottleneck model 130, multiple domain agents may share one bottleneck model 130.

Domain model(s) 105 may be trained to translate into and/or out of a particular domain. For example, one domain model 105 may include an encoder portion (e.g., part of an autoencoder model or a standalone model) that is configured to encode information expressed in that particular domain's DSL into a reduced-dimensionality representation such as a semantically rich vector embedding (discrete or continuous). The domain model 105 may also include an action engine (not depicted, e.g., a decoder that is part of the autoencoder model or a standalone model) that is configured to generate DSL—e.g., sets of actions to be performed/implemented—in the domain. For example, the action engine may use all or part of domain model 105 to decode reduced-dimensionality representations back into information expressed in the particular domain's DSL.

A variety of different domains may be served by domain agents 104. As non-limiting examples, first domain agent 104A may correspond to the natural language domain and may use domain model 105A to translate between its own DSL, natural language, and reduced dimensionality representations of natural language. Second domain agent 104B may correspond to another domain having its own DSL. A DSL may be any manner of conveying information in a particular domain. A particular computer programming language may be the DSL of a domain associated with that programming language. Another domain may have a DSL that includes demonstration input/output pairs of a computer program. Another domain may describe a real or simulated space in terms of an initial state that includes an initial arrangement of one or more real or simulated objects in the space, and a goal state that includes a goal arrangement of the one or more real or simulated objects in the space. Yet another domain may utilize a DSL formed by demonstration input/output pairs. Other domains may be associated with particular computer programs, types of computer programs, types of robots (e.g., self-driving vehicles), and so forth.

Bottleneck models 130 may be trained to reduce the dimensions of representations generated by domain agents 104 using domain models 105, e.g., so that the resulting lower-dimensionality bottleneck representations (e.g., bottleneck embeddings) more succinctly and directly represent the salient features of a semantic concept. In some implementations, bottleneck models 130 may be trained separately from domain models 105. For instance, domain models 105 may be trained, and then domain models 105 may be held constant while bottleneck models 130 are trained to generate bottleneck representations that more succinctly and/or concisely represent underlying semantic concepts.

Cross domain inference system 102 may include modules other than domain agents 104. For example, in FIG. 1, cross domain inference system 102 includes a simulation module 110, an interface module 112, and a virtual assistant cloud portion 114. Any of modules 110-114 may be implemented using any combination of hardware and software. Moreover, any of modules 110-114 may be omitted, combined with other modules, etc.

Cross domain inference system 102 may be operably coupled via one or more computer networks (117) with any number of client computing devices 120 that are operated by any number of users. In FIG. 1, for example, a user 118 operates a client device 120. As used herein, client device(s) 120 may include, for example, one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker (which in some cases may include a vision sensor and/or touchscreen display), a smart appliance such as a smart television (or a standard television equipped with a networked dongle with automated assistant capabilities), and/or a wearable apparatus of the user that includes a computing device (e.g., a watch of the user having a computing device, glasses of the user having a computing device, a virtual or augmented reality computing device). Additional and/or alternative client computing devices may be provided.

In some implementations, client device 120 may include a virtual assistant client portion 122 that is configured to cooperate with virtual assistant cloud portion 114. When the term “virtual assistant” is used herein, it may be understood to include any combination of virtual assistant cloud portion 114 and virtual assistant client portion 122. In some implementations, virtual assistant 114/122 may be configured to semantically process natural language input(s) provided by user 118 to identify one or more intent(s). Based on these intent(s), virtual assistant 114/122 may perform a variety of tasks, such as operating smart appliances, retrieving information, performing tasks, and so forth. Additionally or alternatively, in some implementations, virtual assistant 114/122 may utilize one or more LLMs such as transformers to predict sequences of output tokens (e.g., virtual assistant natural language responses) based on input sequences of tokens (e.g., natural language input provided by user 118).

Simulation module 110 may be configured to simulate actions generated by domain agents 104. For example, if a particular domain agent 104 generates source code that is intended to transition an environment from an initial state to a goal state, simulation module 110 may compile and/or execute the source code to determine outputs and/or a resulting state of the environment. Based on these outputs and/or the resulting state of the environment, cross domain inference system 102, e.g., by way of simulation module 110 and/or domain agent 104, may train domain models 105 and/or bottleneck models 130. In this way, domain agents 104 may engage in simulated “play” with each other and with themselves in order to conduct training of bottleneck models with little or no human supervision.

Interface module 112 may provide one or more human-computer-interfaces (HCIs), such as one or more graphical user interfaces (GUIs) that can be operated by various individuals, such as user 118, to perform various actions made available by cross domain inference system 102. For example, interface module 112 may provide a GUI (e.g., a standalone application or a webpage) at client device that is operable to implement various techniques described herein. Additionally, interface module 112 may facilitate a speech-based interface (including speech-to-text processing, text-to-speech processing, etc.) that allows user 118 to participate in human-to-computer dialogs with virtual assistant 114/122.

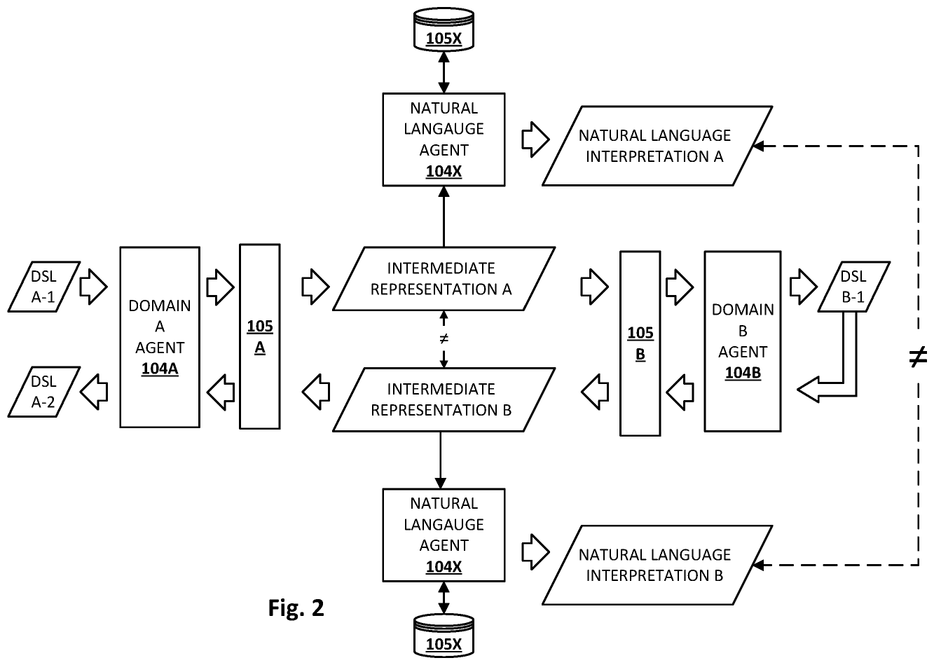

FIG. 2 schematically depicts an example of how various components of FIG. 1 may exchange data in order to implement a semantic concept across disparate domains. Starting at left, user 118 (not depicted in FIG. 2, see FIG. 1) may provide one or more inputs in a first domain (DOMAIN A), such as one or more instances of DSL A-1. Just as other domains are contemplated than those depicted in the figures, other types of inputs may be received as well. One non-limiting example would be base inputs and target outputs to be generated by a computer program—these could be in text form, e.g., typed (or pasted) into a command line interface, or provided as standalone text files. Another non-limiting example would be a recorded sequence of actions performed by a user via a HCI, such as a sequences of keystrokes/mouse actions performed on a GUI (e.g., to accomplish some task), a sequence of spoken commands provided to a virtual assistant, video input to capture movement of an organism or machine for translation into other domains (e.g., natural language description, conversion into animation markup language), etc.

The input DSL-A1 may be processed by a first domain agent 104A (for DOMAIN A) using a domain A model 105A to generate a first intermediate representation A. First intermediate representation A, which may or may not be domain agnostic, may take various forms, such as a vector, embedding, natural language snippet, etc. First intermediate representation A may be processed by a second domain agent 104B for DOMAIN B using a second domain model 105B to generate a predicted DOMAIN B DSL B-1 representation of the semantic concept expressed in the original input DSL A-1.

Suppose the DSL of DOMAIN A is the C++ programming language. Suppose further that the DSL of DOMAIN B corresponds to pairs of images depicting a 2D or 3D space (e.g., a 2D grid of cells that collectively can form an image or pattern) before and after transition of the space from an initial state to a goal state. DSL A-1 may represent source code written in C++ that is meant to accomplish the transition of the space from the initial state to the goal state. DSL B-1 may include a predicted pair of images that depict the space in the initial state and in the goal state.

The process is then shown performed in reverse. Starting at right, second domain agent 104B may process DSL B-1 (e.g., the pair of images depicting the space before and after the transition) using second domain model 105B to generate a second intermediate representation B. As indicated by the #symbol, it may be unlikely that second intermediate representation B is similar to first intermediate representation A. For example, if represented as continuous vector embeddings, first intermediate representation A and second intermediate representation B may be relatively distant from each other in embedding space (with distance being calculated using techniques such as Euclidean distance, cosine similarity, dot product, etc.). Consequently, when first domain agent 104A processes second intermediate representation B using first domain model 105A, the resulting prediction, DSL A-2, may represent predicted C++ source code that differs considerably from DSL A-1. This is especially true if there are multiple different algorithms that would successfully transition the space from the initial state to the goal state, which may often be the case.

This notion is further illustrated in FIG. 2 by the use of a natural language agent 104X. Natural language agent 104X may be configured to process intermediate representations using its own domain model 105X to generate natural language descriptions/interpretations of semantic concepts represented by intermediate representations. In FIG. 2, for instance, natural language agent 104X is depicted twice: once to generate a first natural language interpretation A based on first intermediate representation A; and again to generate a second natural language interpretation B based on second intermediate representation B. As noted above, first intermediate representation A and second intermediate representation B may be considerably different, in spite of them representing the same high-level semantic concept. Consequently, first natural language interpretation A and second natural language interpretation B may be vastly different from each other. This can make interpretating intermediate representations (e.g., for purposes of debugging, training, etc.) challenging, since the same high-level semantic concept may be expressed in myriad different ways.

It may be the case that while the initial input, DSL A-1 (C++ code), correctly transitions the space from the initial state to the goal state, it does so in a very inefficient and/or roundabout way. As a working example, suppose the space is a 2D space with a grid of cells that can be colored to form patterns, like pixels of a digital image. Suppose further that the pattern depicted in the goal state is the same as the pattern depicted in the initial state, except rotated ninety degrees. DSL A-1 may include instructions to manually change every single cell of the grid of cells, regardless of whether those cells are actually changed from the initial state to the goal state. The first natural language interpretation A generated by natural language agent 104X may accurately represent those instructions, but in a way that is as verbose and/or roundabout as the original C++ code.

In contrast, this transition may be represented more simply in DSL B-1, e.g., as before and after images showing the pattern in its initial orientation and rotated by ninety degrees. Consequently, when DSL B-1 is processed in reverse, the resulting C++ code DSL A-2 may carry out the pattern rotation with considerably fewer instructions than DSL A-1. For example, DSL A-2 may only alter cells that actually change their appearance and may implement the pattern rotation more efficiently than on a cell-by-cell basis. The contrast between DSL A-1 and DSL A-2 may be even more evident when comparing the first natural language interpretation A—which may laboriously describe altering every single cell without any description of how the pattern is rotated as a whole—to the second natural language interpretation B—which may succinctly state, “rotate the diagram” or something to that effect. This is shown by the #dashed arrow on the right side of FIG. 2.

Accordingly, in various implementations, one or more bottleneck models (130 in FIG. 1) may be trained to generate more semantically succinct intermediate representations than those depicted in FIG. 2. As noted previously, these semantically succinct intermediate representations may be referred to herein as “bottleneck representations” or “bottleneck embeddings.” By distilling overly complex and/or verbose domain representations of semantic concepts into bottleneck representations using bottleneck models, it is easier to interpret information passed between domain agents because that information will be more semantically succinct and/or consistent.

These bottleneck representations may also allow domain models to perform tasks (or generate scripts that can be execute tasks) in more efficient ways than initially provided by users. For example, when a user provides a source code snippet that accomplishes a task inefficiently, techniques described herein may be used to extract the essential and/or salient features of the task and generate new source code (in the same programming language or a different programming language) that accomplishes the task more efficiently. As one non-limiting example, if the user's source code includes an instance of the bubble sort algorithm being used to sort a sequence of elements, that “bubble sorting” may be abstracted to “sorting,” which in turn may be translated into “quick sorting” or another faster sorting algorithm.

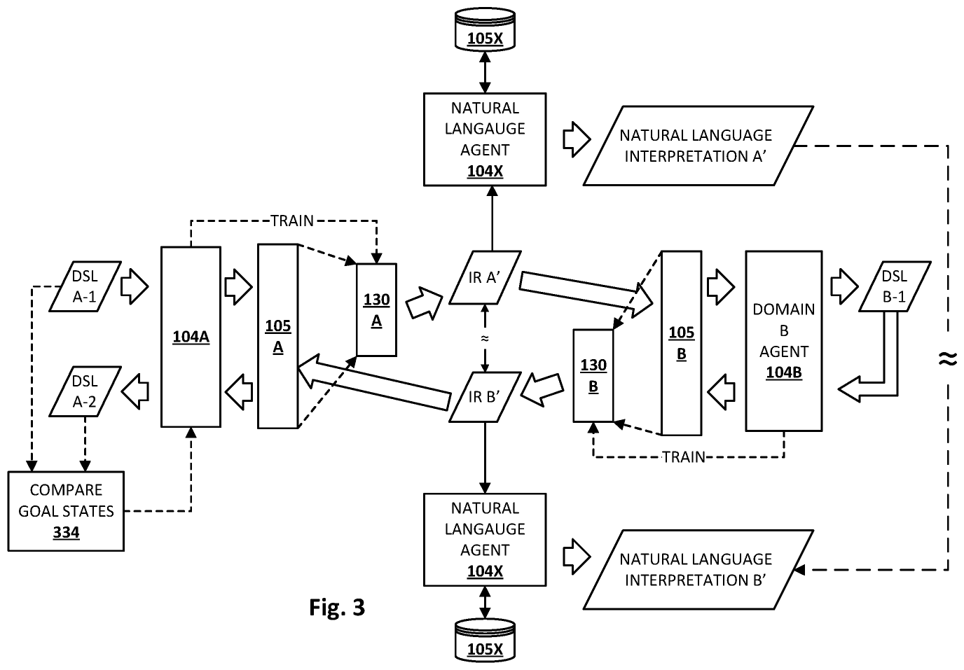

FIG. 3 schematically depicts an example of how bottleneck models may be incorporated into a domain-to-domain translation, in accordance with various implementations. Many elements of FIG. 3 are similar to those depicted in FIG. 2. Starting once again at left, the initial input, DSL A-1, may represent a C++ code snippet that is processed by first domain agent 104A using first domain model 105A. However, rather than simply generating the first intermediate representation A depicted in FIG. 2, the processing of first domain agent 104A continues through a first bottleneck model 130A to generate a first bottleneck intermediate representation IR A′. IR A′ may take various forms, such as an embedding (discrete or continuous), natural language, etc. The size and/or dimensions of IR A′ may typically be smaller than the upstream intermediate representations and may depend on the architecture/size/dimensions of first bottleneck model 130A.

First bottleneck intermediate representation IR A′ may then be processed by second domain agent 104B using second domain model 105B to generate DSL B-1 (e.g., before and after images of the 2D grid of cells). While not shown in FIG. 3, in some implementations, first bottleneck intermediate representation IR ‘A may additionally or alternatively be processed by second domain agent 104B using a second bottleneck model 130B (or even first bottleneck model 130A in some cases).

In any case, DSL B-1 may then be processed in reverse to generate a second bottleneck intermediate representation IR B’. As indicated by the ˜ symbol, if bottleneck model(s) 130A and/or 130B are sufficiently trained, IR A′ and IR B′ may be much more similar to each other than, for example, first intermediate representation A and second intermediate representation B depicted in FIG. 2. If bottleneck intermediate representations IR A′ and IR B′ not sufficiently similar (and/or during training), bottleneck model(s) 130A and/or 130B may be trained by the respective domain agents 104, as indicated by the dashed arrows, e.g., using contrastive learning techniques such as triplet loss.

In addition, natural language agent 104X may be provided once again to generate natural language interpretations for bottleneck intermediate representations IR A′ and IR B′. As indicated by the ˜ symbol on the far right in the dashed arrow, if bottleneck model(s) 130A and/or 130B are sufficiently trained, first natural language interpretation A′ and second natural language interpretation B′ depicted in FIG. 3 may be much more similar to each other than, for example, first natural language interpretation A and second natural language interpretation B depicted in FIG. 2. By condensing intermediate representations using bottleneck models, it is possible to generate more semantically succinct interpretations of semantic concepts than might have been readily achievable without bottleneck models.

Increasing the semantic succinctness of intermediate representations may provide various technical advantages beyond easier interpretation by humans. Individuals increasingly interact with virtual assistants that are powered by LLMs (also referred to as “generative models”). Domain agents described herein may be incorporated into the same systems to allow users to provide inputs in different modalities (e.g., natural language, source code, demonstration input/output pairs, sequences of keystrokes, sequences of menu operations, etc.) and also receive outputs in the different modalities. Configuring these domain agents to utilize bottleneck models and bottleneck intermediate representations as described herein may allow the LLMs to provide more semantically succinct responses and/or may facilitate exchange of data between LLMs that is more interpretable and/or consistent within high level semantic concepts.

As one non-limiting example, a user could provide input in the form of a source code file (e.g., a filesystem path to the file) and a natural language instruction to “summarize the functionality of this code.” This may cause the source code to be encoded, e.g., by a suitable domain agent, into a bottleneck intermediate representation that can then be translated into natural language that succinctly and concisely describes the code's high-level task, stripped of idioms from the particular source code or the source code's programming language. Techniques described herein could also be used to determine semantic equivalence between source code snippets, whether those snippets are written in the same programming language or different programming languages. To the extent two source code snippets accomplish the same semantic task in different ways, the bottleneck representations of those source code snippets (whether embeddings or natural language descriptions) may be similar to each other (e.g., proximate in embedding space) because extraneous noise and other information has been stripped and only salient or highly-semantically-relevant features remain.

Bottleneck intermediate representations may also be useful in the context of LLM-powered virtual assistants for purposes such as prompt engineering. For example, a user conducting research may engage with information expressed in multiple different modalities/domains, such as web pages, videos, audio files, etc. By encoding information from these disparate domains into bottleneck intermediate representations, it is possible to make better use of the limited input bandwidth of LLMs (e.g., some LLMs may be designed to process 512 input tokens at a time) in order to generate output sequences of tokens. For instance, by including more semantically succinct and/or smaller tokens as inputs, it may be possible to incorporate additional input tokens. Moreover, if bottleneck intermediate representations from two different domains (e.g., webpage and video) are sufficiently similar to each other to render them duplicative semantically, then only one of the bottleneck intermediate representations might be applied, leaving other input tokens available for other information (or as null values to simplify self-attention and other computational tasks).

Bottleneck models (e.g., 130A, 130B) may be trained on a variety of different losses, some of which are referred to herein as “auxiliary losses.” Some examples of losses being used for training were described previously regarding FIG. 3. One example was performing contrastive learning based on similarities (or dissimilarities) between bottleneck intermediate representations IR A′ and IR′B. Another example was comparing natural language interpretations A′ and B′.

Another example of a loss being used to train a bottleneck model is depicted on the left in FIG. 3. Starting in the middle, the bottleneck intermediate representation IR′B is processed by first domain agent 104A using first domain model 104A (and/or first bottleneck model 130A in some instances) to once again generate DSL A-2, which in the working example would be predicted source code in C++. Next, goal states of DSL A-1 and DSL A-2 may be compared to determine whether both instances of DSL accomplish the same goal. For example, simulation module 110 may interpret and/or execute the instructions contained in both DSLs A-1 and A-2. If simulation module 110 reveals that the same goal is not accomplished by both DSLs A-1 and A-2, and domain models 105A and 105B are assumed to be adequately trained, then bottleneck model(s) 130A/AB may have introduced semantic error and may be trained, e.g., separately from domain models 105A/B. Another related loss may be used in this particular working example. If there are syntax/compiler errors in DSL A-2 that were not present in DSL A-1, and again assuming domain models 105A and 105B are adequately trained, then bottleneck model(s) 130A/AB may have introduced syntactic error and may be trained, e.g., separately from domain models 105A/B.

By employing the various losses demonstrated by FIG. 3, domain agents 104 may be able to leverage simulation module 110 to simulate domain-specific expressions of semantic concepts. This in turn may enable training of bottleneck models 130, e.g., by domain agents 104, with minimal or no supervision. For example, a first domain agent 104 may use a bottleneck model to generate a bottleneck intermediate representation of a semantic task that is then provided to any number of other domain agents. Those other domain agents may then decode the bottleneck intermediate representations and/or re-encode them using the same or different bottleneck models to generate different expressions of the semantic task in different domains. The various bottleneck intermediate representations of the semantic task can then be compared, e.g., directly to each other or indirectly via their various domain-specific interpretations, to facilitate training of bottleneck models.

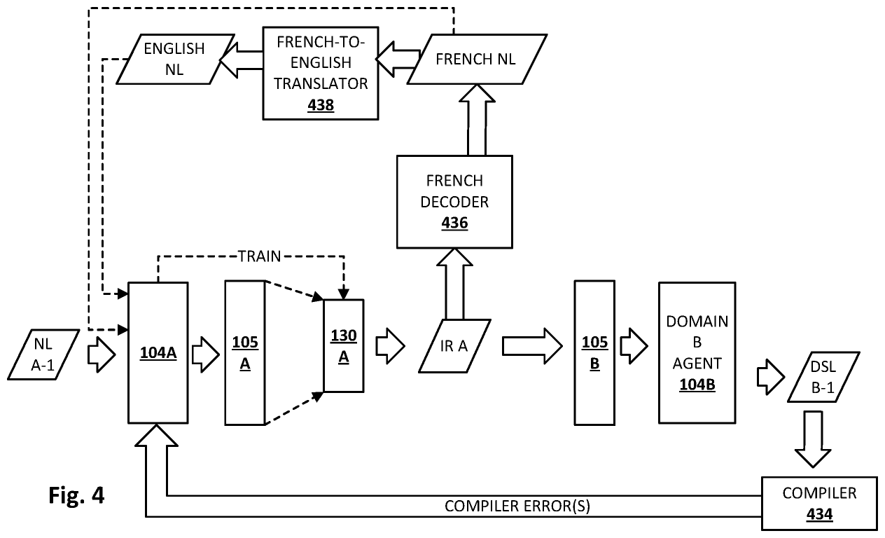

FIG. 4 depicts additional auxiliary losses that may be used to train bottleneck models. In this example, it can be assumed that a first domain A corresponds to natural language and a second domain B corresponds to a particular programming language. It can also be assumed that domain models 105A and 105B are adequately trained to translate accurately from natural language to the particular programming language.

Starting at left, NL A-1 describing a particular high-level task (e.g., transition of an environment from an initial state to a goal state) is processed by first domain agent 104A using first domain model 105A and bottleneck model 130A to generate a bottleneck intermediate representation IR A. Bottleneck intermediate representation IR A is then processed by second domain agent 104B to generate DSL B-1, which may be an expression of the same high-level task.

A compiler 434 may be provided to compile DSL B-1. If domain models 105A/B are assumed to be adequately trained, then to the extent there are syntax and/or compiler errors, those were introduced by bottleneck model 130A. Accordingly, compiler 434 may provide feedback (as shown by the arrow) to first domain again 104A. First domain agent 104A may then train bottleneck model 130A based on these errors, while domain model(s) 105A/B are held constant.

As yet another loss, in FIG. 4, a French decoder 436 (e.g., using all or part of a neural translator autoencoder) may be used to decode IR A into French natural language (French is used here for demonstration only; this may be performed using any language that differs from the original language). A French-to-English translator 438 may then translate (e.g., using a neural translator) the French natural language to translated English natural language. First domain agent 104A may then compare the translated English natural language to the original natural language NL A-1. To the extent these differ, first domain agent 104A may train bottleneck model 130A, e.g., using techniques such as gradient descent, back propagation, etc. This may ensure that bottleneck intermediate representations are properly grounded to a particular language (English in this example). The translation technique depicted in FIG. 4 may be implemented in other ways as well. For example, in FIG. 3, it could be applied, for instance, to one or both of IR A′ and IR B′ to ensure that bottleneck model(s) 130A/B are not introducing shortcuts and remain grounded to a particular interpretable language (English in this example).

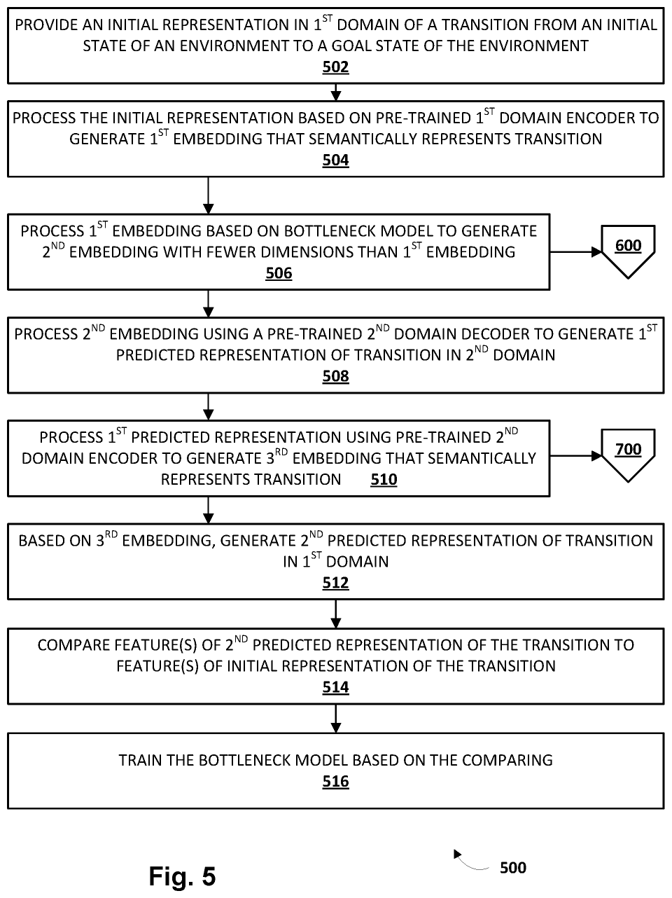

FIG. 5 is a flowchart illustrating an example method 500 for practicing selected aspects of the present disclosure, according to implementations disclosed herein. For convenience, the operations of the flow chart are described with reference to a system that performs the operations. This system may include various components of various computer systems, such as one or more components of cross domain inference system 102. Moreover, while operations of method 500 are shown in a particular order, this is not meant to be limiting. One or more operations may be reordered, omitted or added.

At block 502, the system, e.g., by way of interface module 112 providing an input received from a user 118, may provide an initial representation in a first domain's DSL of a transition from an initial state of an environment to a goal state of the environment. If the user provided the input as natural language to the virtual assistant 114/122, then the initial representation may be the user's natural language input, or another natural language input generated (e.g., suggested) based on the user's initial natural language input, and the initial domain may be the natural language domain. If the user identified or otherwise provided a source code file or source code snippet, then the initial representation may be the source code file/snippet and the initial domain may be a domain in which the DSL is the programming language in which the source code file/snippet was written. And so on.

At block 504, the system, e.g., by way of a first domain agent 104A, may process the initial representation in the first domain based on a pre-trained first domain encoder (e.g., part of first domain model 105A) to generate a first embedding (e.g., intermediate representation A in FIG. 2) that semantically represents the transition. As noted previously, this first embedding may semantically represent a high-level concept (e.g., a transition from an initial state to a goal state) associated with the initial representation in an overly verbose and/or inefficient way, including other noise and/or extraneous information. Moreover, if only domain models (105) are used to generate such intermediate representations, then there is little that constrains multiple different intermediate representations representing the same high-level semantic concept to be similar to each other.

Accordingly, at block 506, the system, e.g., by way of first domain agent 104A, may process the first embedding based on a bottleneck model (e.g., 130A) to generate a second embedding (e.g., IR A′ in FIG. 3, or more generally, a second intermediate and/or transferable representation) with fewer dimensions than the first embedding. In various implementations, the second embedding also semantically represents the same transition as the first embedding, except more efficiently, succinctly, and/or without extraneous information or noise.

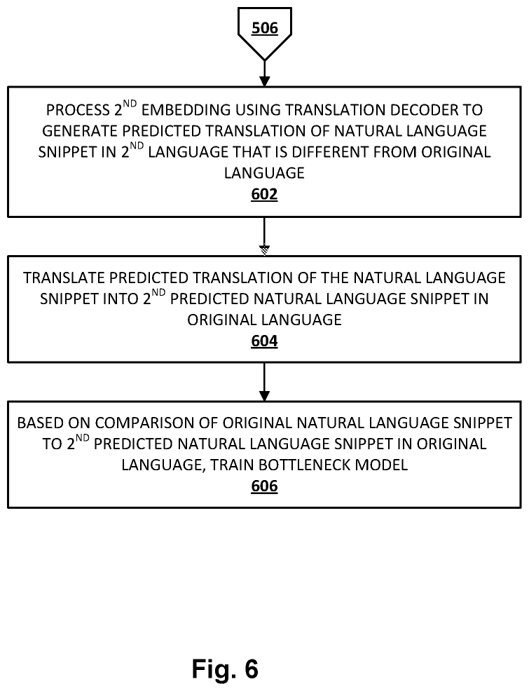

As shown in FIG. 5, at this point in some implementations, the second embedding may be processed by a separate process 600 that is depicted in FIG. 6 as part of using another auxiliary loss to train bottleneck models. In the meantime, method 500 may continue to block 508, at which point the system, e.g., by way of second domain agent 104B, may process the second embedding using a pre-trained second domain decoder (e.g., part of second domain model 105B). As a result of this processing, a first predicted representation (e.g., DSL B-1 in FIGS. 2-4) of the transition from the initial state of the environment to the goal state of the environment may be generated in the second domain's DSL.

At block 510, the system, e.g., by way of second domain agent 104B, may process the first predicted representation (e.g., DSL B-1) using a pre-trained second domain encoder (e.g., part of second domain model 105B) to generate a third embedding (e.g., intermediate representation B in FIG. 2 or bottleneck intermediate representation IR B′ in FIG. 3) that semantically represents the transition. As shown in FIG. 5, at this point in various implementations, control may pass to one or both of block 512 of method 500 and to method 700.

Continuing with method 500 (method 700 will be described below), based on the third embedding, at block 512, the system, e.g., by way of first domain agent 104A, may generate, in the first domain, a second predicted representation (e.g., DSL A-2 in FIG. 2 and FIG. 3) of the transition from the initial state of the environment to the goal state. Thus, blocks 502-512 have resulted in two representations of the transition in the first domain, DSL A-1 and DSL A-2.

At block 514, the system, e.g., by way of simulation module 110 or one or more domain agents, may compare one or more features of the second predicted representation (e.g., DSL A-2) of the transition to one or more features of the initial representation (e.g., DSL A-1) of the transition. These features may include, for instance, goal states, words, n-grams, visual features, syntactical features, etc. At block 516, the system, e.g., by way of first domain agent 104A and/or second domain agent 104B, may train the bottleneck model (e.g., 130A) based on the comparing of block 514, e.g., using techniques such as gradient descent, back propagation, etc.

FIG. 6 is a flowchart illustrating an example method 600 for practicing selected aspects of the present disclosure—in particular, using an additional auxiliary loss function to further train bottleneck models to be grounded to a particular natural language (English in this example)—according to implementations disclosed herein. For convenience, the operations of the flow chart are once again described with reference to a system that performs the operations. This system may include various components of various computer systems, such as one or more components of cross domain inference system 102. Moreover, while operations of method 600 are shown in a particular order, this is not meant to be limiting. One or more operations may be reordered, omitted or added.

Before turning to the operations of method 600, assume for purposes of explaining FIG. 6 that the initial representation provided at block 502 comprised an original natural language snippet describing, in a first language (e.g., English), the transition from the initial state of the environment to the goal state of the environment. This is not meant to be limiting, and the operations of method 600 can be performed at other opportunities.

At block 602, the system, e.g., by way of an element such as French decoder 436, may process the second embedding generated at block 506 of FIG. 5 using a translation decoder model (e.g., part of a neural translator/autoencoder) to generate a predicted translation of the natural language snippet in a second language (e.g., French, German, Chinese, etc.) that is different from the first language.

At block 604, the system, e.g., by way of a component such as French-to-English translator 438, may translate the predicted translation of the natural language snippet into a second predicted natural language snippet in the first language (e.g., back to English). French-to-English translator 438 may use and/or be a neural translator, in some cases. Based on a comparison of the original natural language snippet to the second predicted natural language snippet in the first language, at block 606, the system may train the bottleneck model (e.g., 130). For example, to the extent the original natural language snippet differs from the second predicted natural language snippet in the first language, that “error” may be used to train the bottleneck model. Intuitively, the process of method 600 may have the effect of “grounding” bottleneck intermediate representations to a particular natural language, such as English.

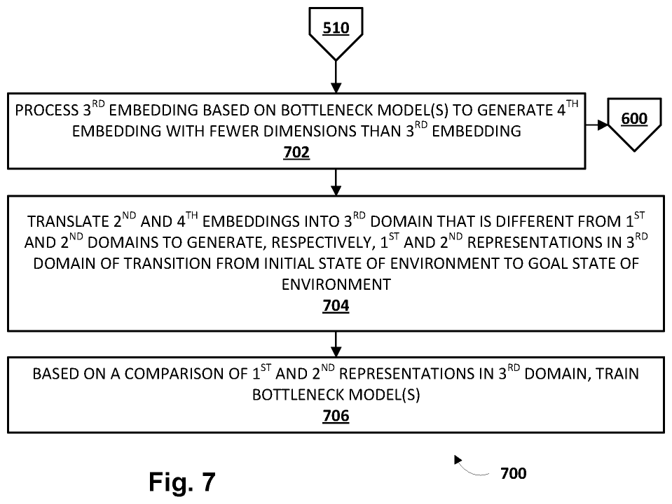

FIG. 7 is a flowchart illustrating an example method 700 for practicing selected aspects of the present disclosure, according to implementations disclosed herein. As explained previously and as shown in FIG. 7, method 700 may begin at generation of the third embedding at block 510 of method 500. In various implementations, the operations of blocks 702-706 of method 700 may be performed in addition to (e.g., in parallel with) and/or instead of the operations of blocks 512-516 of method 500.

At block 702, the system, e.g., by way of second domain model 104B, may process the third embedding generated at block 710 based on one or more of the bottleneck models to generate a fourth embedding with fewer dimensions than the third embedding. An example of such a fourth embedding is IR B′ in FIG. 3. (The second embedding in this example may be IR A′ in FIG. 3). As shown in FIG. 7, block 702 is another example where control can pass to method 600 of FIG. 6, so that the auxiliary loss demonstrated in FIG. 6 can be further applied to ground bottleneck models to a particular language.

At block 704, the system, e.g., by way of a component such as natural language agent 104X, may translate the second and fourth embeddings (e.g., IR A′ and IR B′ in FIG. 3) into a third domain (e.g., natural language in FIG. 3) that is different from the first and second domains. This translation may generate, respectively, first and second representations in the third domain of the transition from the initial state of the environment to the goal state of the environment. In FIG. 3, for instance, the first representation in the third domain was the natural language interpretation A′ of bottleneck embedding IR A′, and the second representation in the third domain was the natural language interpretation B′ of bottleneck embedding IR B′. Based on a comparison of the first and second representations in the third domain, at block 716, the system may train one or more of the bottleneck models (e.g., 130A and/or 130B in FIG. 3).

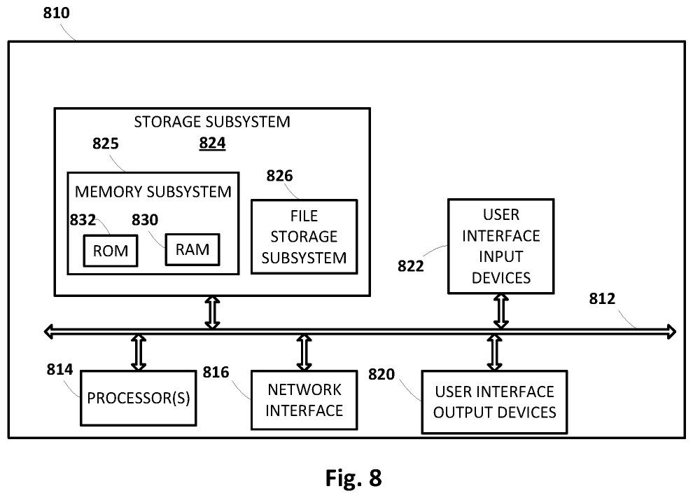

FIG. 8 is a block diagram of an example computing device 810 that may optionally be utilized to perform one or more aspects of techniques described herein. In some implementations, one or more of client computing device 120, cross domain inference system 102, and/or other component(s) may comprise one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of the methods 500-700 of FIGS. 5-7.

These software modules are generally executed by processor 814 alone or in combination with other processors. Memory 825 used in the storage subsystem 824 can include a number of memories including a main random-access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
providing an initial representation in a first domain of a transition from an initial state of an environment to a goal state of the environment;
processing the initial representation in the first domain based on a pre-trained first domain encoder to generate a first embedding that semantically represents the transition;
processing the first embedding based on one or more bottleneck models to generate a second embedding with fewer dimensions than the first embedding, wherein the second embedding also semantically represents the transition;
processing the second embedding using a pre-trained second domain decoder to generate a first predicted representation of the transition from the initial state of the environment to the goal state of the environment, wherein the first predicted representation is in the second domain;
processing the first predicted representation using a pre-trained second domain encoder to generate a third embedding that semantically represents the transition;
based on the third embedding, generating a second predicted representation of the transition from the initial state of the environment to the goal state, wherein the second predicted representation is in the first domain;
comparing one or more features of the second predicted representation of the transition to one or more features of the initial representation of the transition; and
training one or more of the bottleneck models based on the comparing.

2. The method of claim 1, wherein the initial representation comprises an original natural language snippet describing, in a first language, the transition from the initial state of the environment to the goal state of the environment.

3. The method of claim 2, further comprising:
processing the second embedding using a translation decoder to generate a predicted translation of the natural language snippet in a second language that is different from the first language;
translating the predicted translation of the natural language snippet into a second predicted natural language snippet in the first language; and
based on a comparison of the original natural language snippet to the second predicted natural language snippet in the first language, training one or more of the bottleneck models.

4. The method of claim 1, wherein the generating comprises processing the third embedding using a first domain decoder to generate the second predicted representation of the transition from the initial state of the environment to the goal state.

5. The method of claim 1, wherein the one or more bottleneck models include a first bottleneck model, and the generating comprises:
processing the third embedding using the first bottleneck model or a second bottleneck model to generate a fourth embedding with fewer dimensions than the third embedding; and
based on the fourth embedding, generating the second predicted representation of the transition from the initial state of the environment to the goal state.

6. The method of claim 5, wherein generating the second predicted representation based on the fourth embedding comprises decoding the fourth embedding using a first domain decoder.

7. The method of claim 5, wherein generating the second predicted representation based on the fourth embedding comprises decoding the fourth embedding using the first bottleneck model.

8. The method of claim 1, wherein the comparing comprises comparing the goal state of the initial representation with a predicted goal state of the second predicted representation of the transition.

9. The method of claim 1, wherein the environment comprises a computer application executing on a computing device.

10. The method of claim 1, wherein the environment comprises a real or simulated space, the initial state comprises an initial arrangement of one or more real or simulated objects in the space, and the goal state comprises a goal arrangement of the one or more real or simulated objects in the space.

11. The method of claim 1, wherein the first domain comprises a computer programming language domain and the second domain comprises demonstration input/output pairs.

12. The method of claim 1, wherein one or more of the bottleneck models comprises a transformer model.

13. A method implemented using one or more processors and comprising:
providing an initial representation in a first domain of a transition from an initial state of an environment to a goal state of the environment;
processing the initial representation in the first domain based on a pre-trained first domain encoder to generate a first embedding that semantically represents the transition;
processing the first embedding based on one or more bottleneck models to generate a second embedding with fewer dimensions than the first embedding;
processing the second embedding using a pre-trained decoder for a second domain to generate a first predicted representation of the transition from the initial state of the environment to the goal state of the environment, wherein the first predicted representation is in the second domain;
processing the first predicted representation using a pre-trained second domain encoder to generate a third embedding that semantically represents the transition;
processing the third embedding based on one or more of the bottleneck models to generate a fourth embedding with fewer dimensions than the third embedding;
translating the second and fourth embeddings into a third domain that is different from the first and second domains to generate, respectively, first and second representations in the third domain of the transition from the initial state of the environment to the goal state of the environment; and
based on a comparison of the first and second representations in the third domain, training one or more of the bottleneck models.

14. The method of claim 13, wherein the environment comprises a computer application executing on a computing device.

15. The method of claim 13, wherein the environment comprises a real or simulated space, the initial state comprises an initial arrangement of one or more real or simulated objects in the space, and the goal state comprises a goal arrangement of the one or more real or simulated objects in the space.

16. The method of claim 13, wherein the first domain comprises a computer programming language domain and the second domain comprises demonstration input/output pairs.

17. The method of claim 13, wherein the bottleneck model comprises a transformer model.

18. A method implemented using one or more processors, comprising:
providing an initial representation in a first domain of a transition from an initial state of an environment to a goal state of the environment;
processing the initial representation in the first domain based on a pre-trained first domain encoder to generate a first transferable representation that semantically represents the transition;
processing the first transferable representation based on a bottleneck model to generate a second transferable representation with fewer dimensions than the first transferable representation, wherein the second transferable representation also semantically represents the transition;
processing the second transferable representation using a pre-trained second domain decoder to generate a first predicted representation of the transition from the initial state of the environment to the goal state of the environment, wherein the first predicted representation is in the second domain;
processing the first predicted representation using a pre-trained second domain encoder to generate a third transferable representation that semantically represents the transition;
based on the third transferable representation, generating a second predicted representation of the transition from the initial state of the environment to the goal state, wherein the second predicted representation is in the first domain;
comparing one or more features of the second predicted representation of the transition to one or more features of the initial representation of the transition; and
training the bottleneck model based on the comparing.

19. The method of claim 18, wherein the generating comprises processing the third transferable representation using a first domain decoder to generate the second predicted representation of the transition from the initial state of the environment to the goal state.

20. The method of claim 18, wherein bottleneck model comprises a first bottleneck model, and the generating comprises:
processing the third transferable representation using the first bottleneck model or a second bottleneck model to generate a fourth transferable representation with fewer dimensions than the third transferable representation; and
based on the fourth transferable representation, generating the second predicted representation of the transition from the initial state of the environment to the goal state.
